(19) United States
(12) Patent Application Publication
(10) Pub. No.: US 2015/0184785 A1
(43) Pub. Date: Jul. 2, 2015

(54) SYSTEM AND METHOD FOR REPAIR AND MAINTENANCE OF PIPELINES

(71) Applicant: Edward Thomas Richards, JR., Folsom, CA (US)

(72) Inventor: Edward Thomas Richards, JR., Folsom, CA (US)

(21) Appl. No.: 14/142,499

(22) Filed: Dec. 27, 2013

(51) Int. Cl. F16L 55/1645

(52) U.S. Cl. CPC F16L 55/1645

(57) ABSTRACT

Systems and methods for the repair and maintenance of pipelines are disclosed. An example embodiment includes a pipeline maintenance apparatus comprising: a body encased in a skid, the skid being fabricated from a low-friction material, the body including a quick-release chuck at a forward end of the body, the body including an epoxy inflow fitting and a motor power source fitting at a rear end of the body, the body further including a motor for spinning the quick-release chuck using power sourced via the motor power source fitting; an epoxy applicator spin head being removably attachable to the quick-release chuck; and an epoxy delivery tube coupled to the epoxy inflow fitting at a rear end of the epoxy delivery tube, a forward end of the epoxy delivery tube being configured to deliver a pre-determined quantity of epoxy to the epoxy applicator spin head.

### TECHNICAL FIELD

The disclosed subject matter relates to the field of pipes, pipelines, venting, ducting, conduit, and other passageway technology, and particularly to the repair and maintenance of pipelines.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2013, Edward Thomas Richards, Jr., All Rights Reserved.

### BACKGROUND

Conventional technologies provide numerous systems and methods to repair and maintain pipelines, conduits, and passageways from the inside in order to restore the integrity of these pipeline systems. It is often necessary to perform in situ rehabilitation of these pipeline systems; because, the surrounding infrastructure may not permit a sufficient level of access. Some conventional pipe repair systems use a fabric liner impregnated with a resin and inserted into a pipe. However, the fabric liner can be expensive and difficult to install. Some pipe repair systems or pipeline pigs use devices with wheels, tracks, or rails. However, the wheels, tracks, or rails can get stuck in ruts or irregular areas in the interior of the pipe. Other pipe repair systems are designed to only be pulled through a pipe. However, it is not always possible to get access to the interior of a pipe from an end of the pipeline where these devices must be pulled. Still other pipeline repair systems are designed for large diameter or straight pipe segments. These systems cannot support small diameter pipelines with turns, angles, and curves. Still other pipeline repair systems use a robotic device configured to move at a constant rate through the pipeline. These systems cannot slow or stop the pace of the device if a particular portion of the pipeline may need special care. Other pipeline repair systems use a heat cured epoxy that must be delivered to the applicator while hot. These systems require that the pipeline device include a heating element or complex delivery mechanisms, which increases cost and risk in using the device.

### BRIEF DESCRIPTION OF THE DRAWINGS

Embodiments are illustrated by way of example and not limitation in the figures of the accompanying drawings, in which:

FIG. 1 illustrates an example embodiment of the pipeline maintenance apparatus with an attached epoxy applicator spin head shown inside of a pipe;

FIG. 2 illustrates an example embodiment showing a detail of the epoxy applicator spin head;

FIG. 3 illustrates an example embodiment of the pipeline maintenance apparatus with an attached pipe cleaning spin head shown inside of a pipe;

FIG. 4 illustrates an example embodiment showing a detail of the pipe cleaning spin head;

FIGS. 5 and 6 illustrate a detail of the head end or forward end of the body of the pipeline maintenance apparatus of an example embodiment;

FIG. 7 illustrates a detail of the tail end or rear end of the body of the pipeline maintenance apparatus of an example embodiment;

FIG. 8 illustrates a cutaway view of the skid, body, and epoxy applicator spin head of the pipeline maintenance apparatus of an example embodiment inside of a pipe, the view showing the inserted epoxy supply line and the video camera;

FIG. 9 illustrates a cutaway view of the skid, body, and epoxy applicator spin head of the pipeline maintenance apparatus of an example embodiment inside of as pipe, the view showing the skid attachment screws or bolts;

FIG. 10 illustrates a rear perspective view of the skid, body, and epoxy applicator spin head of the pipeline maintenance apparatus of an example embodiment;

FIG. 11 illustrates an exploded, view of the skid, body, epoxy applicator spin head, the skid attachment screws or bolts, the epoxy supply line, the video camera, and the motor power source fitting and push rod of the pipeline maintenance apparatus of an example embodiment;

FIG. 12 illustrates an alternative embodiment of the epoxy applicator spin head; and

FIGS. 13 through 15 illustrate alternative embodiments of the skid of the pipeline maintenance apparatus.

### DETAILED DESCRIPTION

In the following detailed description reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

According to various example embodiments of the disclosed subject matter as described herein, there are described and claimed systems and methods for the repair and maintenance of pipelines. In the various embodiments described herein the pipe or pipeline as denoted herein can include conventional pipes, piping, or pipelines, venting, ducting, conduit, and/or other tubular or rectangular hollow passageway fabricated form a variety of materials including metal, polyvinyl chloride (PVC) or other plastics, composite materials, ceramic, fiberglass, or concrete. In an example embodiment, the pipeline maintenance apparatus as described herein can operate in pipes of a diameter from two inches to several feet. The example embodiments provide a system and method far in situ maintenance and repair of various types and sizes of pipes and pipeline systems. The example embodiments can be used to apply a coating of pre-mixed epoxy on the inside surface of a pipe without having to dig up or otherwise disturb an installed pipeline system. The applied epoxy does not need to be heated or heat applied. The epoxy serves to seal and protect the interior surface of the pipe, repair cracks, holes, or corroded areas, and lengthen the service life of the pipeline system. The example embodiments can be used in pipeline arrangements with bends, turns, angles, curves, or reduced diameter segments. The example embodiments are designed to be pushed or pulled through a pipe instead of only being pulled. A skid enables the apparatus to move through a pipe without wheels, tracks, or rails. Various embodiments also provide a quick-release chuck to enable removable attachment of an epoxy applicator spin head or a pipe cleaning spin head. Some embodiments also provide a video camera at the forward end of the apparatus to enable a user to view the inside of the pipe while the apparatus is in operation. A detailed description of various example embodiments of the system and apparatus is provided below.

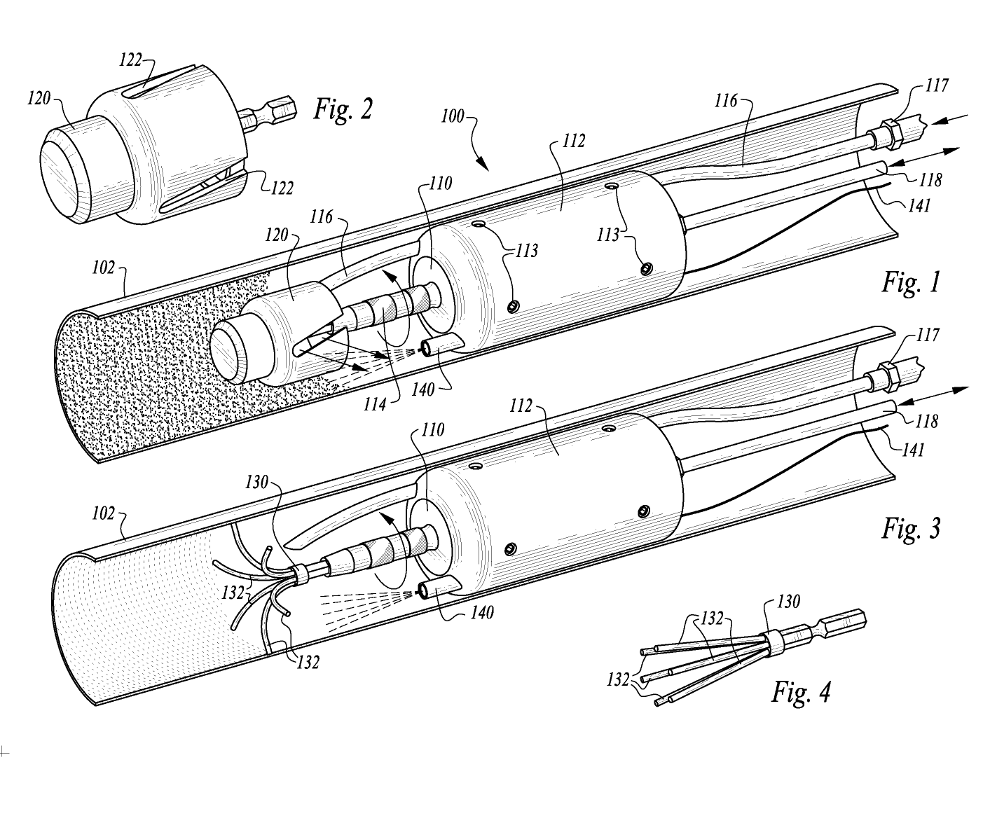

Referring now to FIG. 1 an example embodiment of a pipeline maintenance apparatus 100 is illustrated. In particular, FIG. 1 illustrates an example embodiment 100 of the pipeline maintenance apparatus with an attached epoxy applicator spin head 120 shown inside of as pipe 102. The pipeline maintenance apparatus 100 of an example embodiment comprises as body 110 encased in a skid 112. The body 110 can include a pneumatic or electric drill motor for spinning the quick-release chuck 114 and epoxy applicator spin head 120 attached thereto at a forward end of the body. The drill motor of body 10 draws power from the motor power source fitting 118 at a rear end of the body. For embodiments using a pneumatic drill motor, the motor power source fitting 118 can be a pressurized air fitting and tube for supplying pressurized air to the pneumatic drill motor. For embodiments using an electric drill motor, the motor power source fitting 118 can be an electric fitting and conductive wire for supplying electric power to the electric drill motor. The motor power source fitting 118 can also serve as an attachment point for a pushrod used to push or pull the pipeline maintenance apparatus 100 through pipe 102. In an example embodiment, the drill and/or drill motor is of a type identified as ail Advanced Tool Design Pneumatic Motor, Model-#2131.

The skid 112 encases the body 110 in a low-friction material, such as polyethylene, polytetrafluoroethylene (PTFE), plastics, composites, or other low-friction materials. The skid 112 can he fabricated as a single hollow cylinder or as two halves of a hollow cylinder. The single hollow cylinder or the two cylinder halves of the skid 112 can be attached to and around the body 110 using recessed screws or bolts 113. The quick-release chuck 114 at the forward end of the body 110 operates to enable a user to pull an outer jacket of the chuck 114 down and toward the body 110 as a spin head is inserted into the top end of the chuck 114. Releasing the outer jacket of the chuck 114 locks the spin head into place in the chuck 114. Thus, the epoxy applicator spin head 120 is removably attachable to the quick-release chuck 114. As a result, activation of the drill motor within the body 110 will cause the chuck 114 and attached spin head to turn.

In an example embodiment, the pipeline maintenance apparatus 100 can be used with at least two kinds of removable spin heads: 1) an epoxy applicator spin head 120 as shown in FIGS. 1 and 2, and 2 a pipe cleaning spin head 130 shown in FIGS. 3 and 4. The epoxy applicator spin head 120 is used to atomize and apply liquefied epoxy to the interior surface of the pipe 102 as shown in FIG. 1. FIG. 2 illustrates an example embodiment showing a detail of the epoxy applicator spin head 120, The epoxy applicator spin head 120 includes a plurality of slots 122 from winch the atomized epoxy is expelled when the epoxy applicator spin head 120 is spinning while in operation. As shown in FIG. 12, an alternative embodiment of the epoxy applicator spin head 125 can be implemented with holes 126 instead of slots 122 to atomize and apply the epoxy differently. The epoxy applicator spin head 120 includes a fitting at one end configured to fit into the quick-release chuck 114. The liquefied epoxy is delivered to a hollow interior region 123 (see FIG. 11 of the epoxy applicator spin head 120 by a forward end of the epoxy delivery tube 116 (also denoted the epoxy supply line). The epoxy delivery tube 116 is configured to deliver a pre-determined quantity of the pre-mixed liquefied epoxy to the hollow interior region 123 of the epoxy applicator spin head 120. The body 110 includes an epoxy inflow fitting 117 at a rear end of the body 110 to which an epoxy reservoir can be attached with an appropriate length of tubing. The pre-determined quantity of epoxy delivered to the epoxy applicator spin head 120 can be sourced from the removably attachable epoxy reservoir. In an example embodiment, the epoxy can he of a type identified as Quik Pox—30 and 60, Epoxy Resin for Lateral—Resin Base. The epoxy can be delivered to the epoxy applicator spin head 120 at ambient temperature.

FIG. 3 illustrates an example embodiment of the pipeline maintenance apparatus 100 with an attached pipe cleaning spin head 130 shown inside of pipe 102. The pipe cleaning spin head 130 includes a plurality of filaments 132 extending therefrom. The filaments 132 can be fabricated from woven steel wires, plastic, or similar materials. When in operation, the rotation of the pipe cleaning spin head 130 causes the filaments 132 to splay outwardly as shown in FIG. 3. As a result of the spinning and splaying action, the filaments 132 make contact with the interior surface of the pipe 102 and serve to brush contaminants from the pipe surface. FIG. 4 illustrates an example embodiment showing a detail of the pipe cleaning spin head 130. The pipe cleaning spin head 130 includes a fitting at one end configured to fit into the quick-release chuck 114.

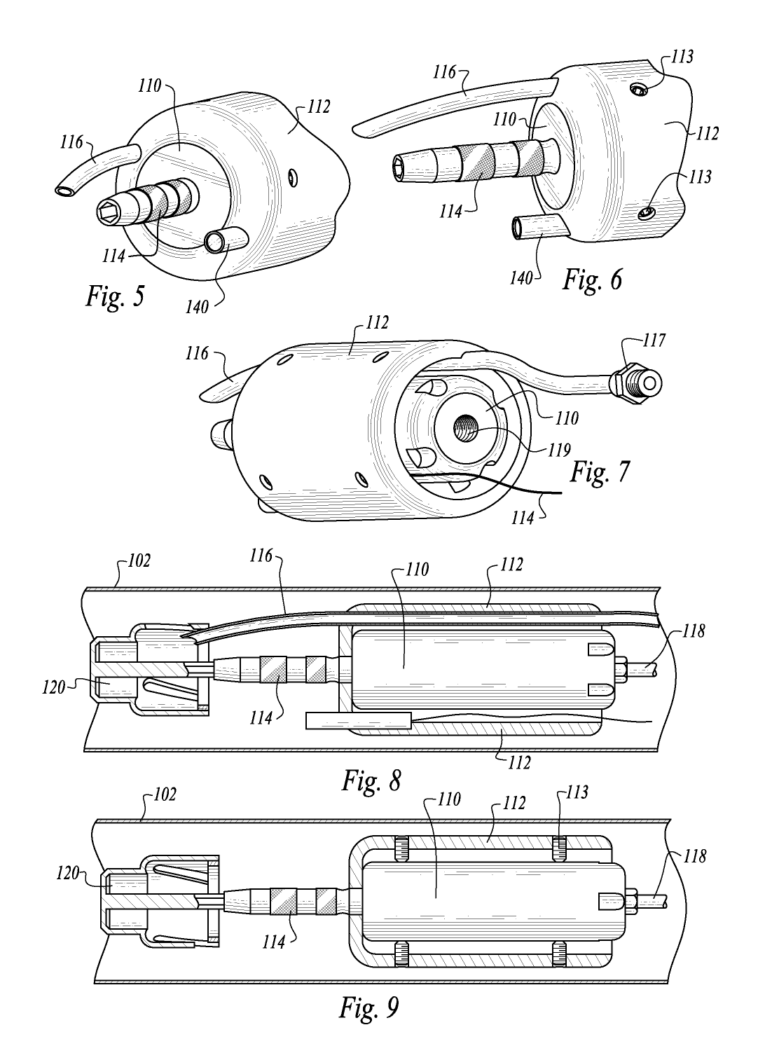

FIGS. 5 and 6 illustrate a detail of the head end or forward end of the body 110 of the pipeline maintenance apparatus 100 of an example embodiment. As shown, the body 110 is encased by the skid 112. The quick-release chuck 114 extends from the forward end of the body 110. In the embodiment shown, a spin bead is not attached to the quick-release chuck 114. FIGS. 5 and 6 also illustrate the forward end of the epoxy delivery tube 116 and the video camera 140. The video camera 140 can be a standard type of camera. In one embodiment, a camera used can be identified as a Lawmate, model-#CMSS42.

The camera 140 includes an adjustable intensity light at the lens of the camera 140 to illuminate the region ahead of the pipeline maintenance apparatus 100. The intensity of the camera light can be adjusted using the wire 141 extending from the rear end of the body 110 as shown in FIG. 7. The wire 141 can also serve to transfer the video image data from the camera 140 to a recorder or rendering device outside of pipe 102. FIG. 6 also shows the screws or bolts 113 used to secure the skid 112 to the body 110.

FIG. 7 illustrates a detail of the tail end or rear end of the body 110 of the pipeline maintenance apparatus 100 of an example embodiment. The rear end of the body 110 includes an orifice 119 into which the motor power source fitting 118 can be secured. For embodiments using a pneumatic drill motor, the motor power source fitting 118 can be a pressurized air fitting and tube for supplying pressurized air to the pneumatic drill motor. For embodiments using an electric drill motor, the motor power source fitting 118 can be an electric fitting and conductive wire for supplying electric power to the electric drill motor. The motor power source fitting 118 and the orifice 119 can also serve as an attachment point for a pushrod used to push or pull the pipeline maintenance apparatus 100 through pipe 102. FIG. 7 also shows the epoxy inflow fitting 117 at the rear end of the body 110 to which an epoxy reservoir can be attached.

FIG. 8 illustrates a cutaway view of the skid 112, body 110, and epoxy applicator spin head 120 of the pipeline maintenance, apparatus 100 of an example embodiment inside of a pipe 102, the view showing the inserted epoxy supply line 116 and the video camera 140.

FIG. 9 illustrates another cutaway view of the skid 112. body 110, and epoxy applicator spin head 120 of the pipeline maintenance apparatus 100 of an example embodiment inside of a pipe 102, the view showing the skid 112 attachment screws or bolts 113.

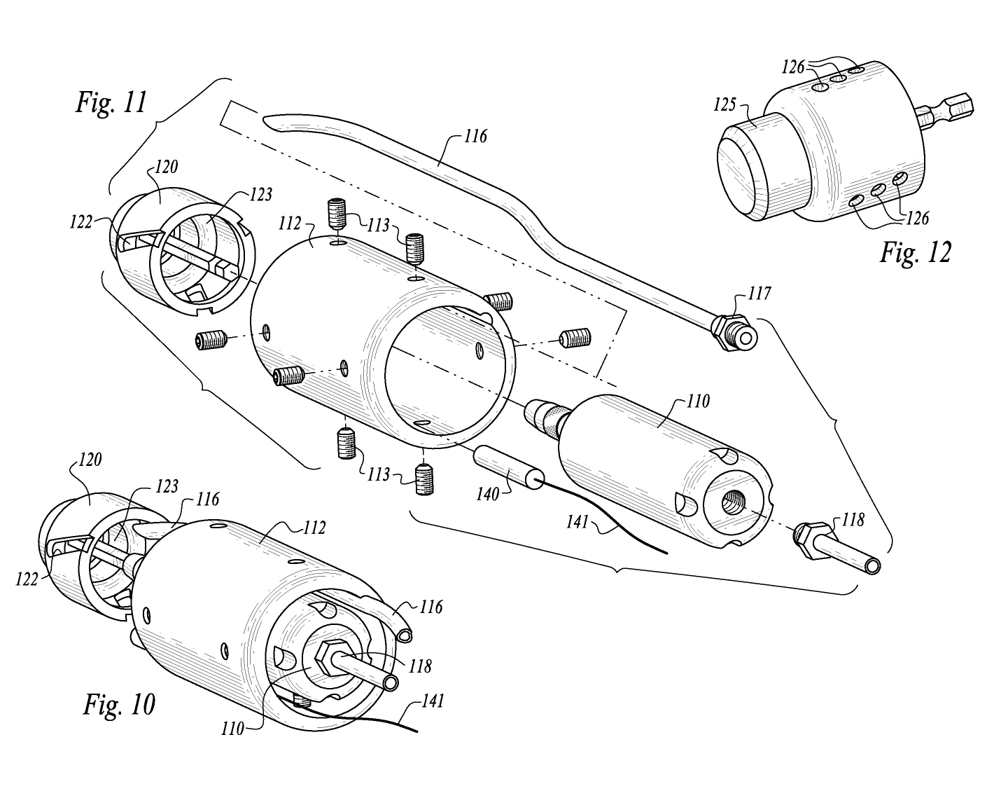

FIG. 10 illustrates a rear perspective view of the skid 112, body 110, and epoxy applicator spin head 120 of the pipeline maintenance apparatus 100 of an example embodiment. This view shows the hollow interior region 123 of the epoxy applicator spin head 120 into which the liquefied epoxy is delivered by the epoxy delivery tube 116 while the device is in operation. FIG. 10 also shows the rear end of the body 110 and the motor power source fitting 118 that has been secured to the body. FIG. 10 also shows the rear end of the epoxy delivery tube 116 and the video camera wire 141 as described above.

FIG. 11 illustrates an exploded view of the skid 112, body 110, epoxy applicator spin head 120, the skid attachment screws or bolts 113, the epoxy supply line 116, the video camera 140, the motor power source fitting 118 and push rod of the pipeline maintenance apparatus 100 of an example embodiment. This view illustrates the hollow cylindrical shape of the skid 112 and its configuration for encasing the body 110. The skid 112 enables the pipeline maintenance apparatus 100 to slide through the inside of pipe 102 with a low degree of friction.

FIG. 12 illustrates an alternative embodiment of the epoxy applicator spin head. In this embodiment, the epoxy applicator spin head 125 can be implemented with holes 126 instead of slots 122 to atomize and apply the epoxy differently. It will be apparent to those of ordinary skill in the art in view of the disclosure herein that the size, shape, and arrangement of holes 126 can be varied to achieve a desired epoxy atomization and application effect.

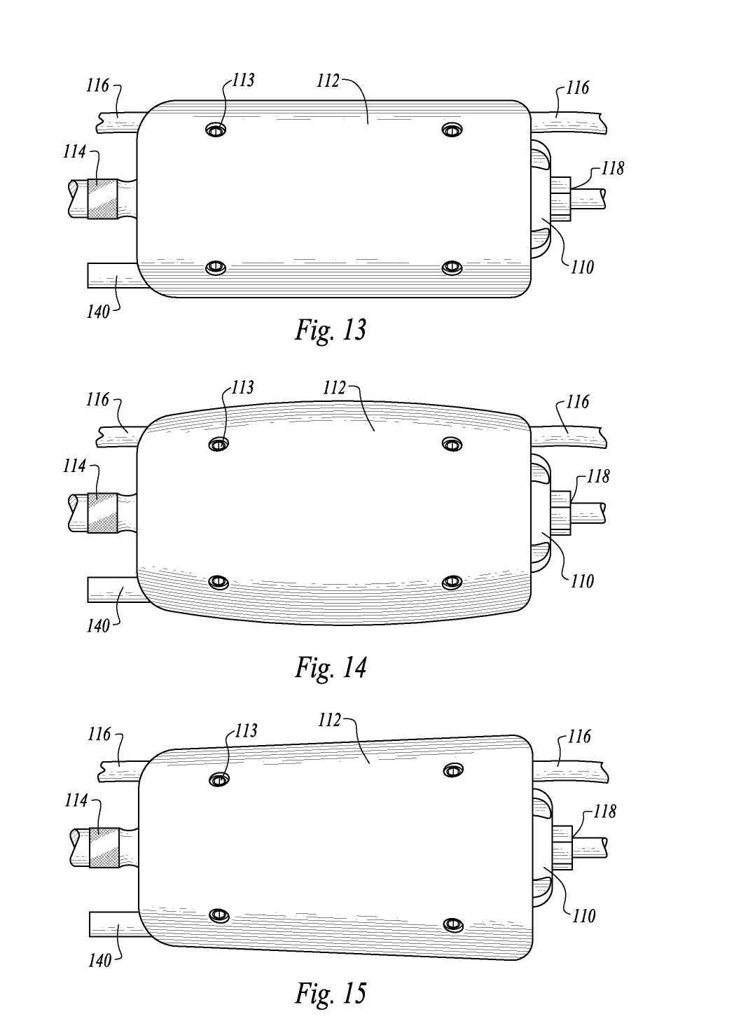

FIGS. 13 through 15 illustrate alternative embodiments of the skid 112 of the pipeline maintenance apparatus 100. In FIG. 13, an example embodiment of the skid 112 is fabricated with a dimension of the skid 112 at the middle being generally the same as dimensions of the skid 112 at the ends of the skid 112. In FIG. 14, an example embodiment of the skid 112 is fabricated with a dimension of the skid 112 at the middle being larger than dimensions of the skid 112 at the ends of the skid 112. In FIG. 15, an example embodiment of the skid 142 is fabricated with a dimension of the skid 112 at the rear end being larger than a dimension of the skid 112 at the forward end. It will be apparent to those of ordinary skill in the art in view of the disclosure herein that the size, shape, and arrangement of skid 112 can he varied to achieve a desired low friction effect.

The illustrations of embodiments described herein are intended to provide a general understanding of the structure of various embodiments, and they are. not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure, The figures herein are merely representational and may not be drawn to scale. Certain proportions thereof may be exaggerated, while others may he minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations ma all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, systems and methods for the repair and maintenance of pipelines are disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A pipeline maintenance apparatus comprising:
a body encased in a skid, the skid being fabricated from a low-friction material, the body including a quick-release chuck at a forward end of the body, the body including an epoxy inflow fitting and a motor power source fitting at a rear end of the body, the body further including a motor for spinning the quick-release chuck using power sourced. via the motor power source fitting;
an epoxy applicator spin head being removably attachable to the quick-release chuck; and
in epoxy delivery tube coupled to the epoxy inflow fining at a rear end of the epoxy delivery tube, a forward end of the epoxy delivery tube being configured to deliver a pre-determined quantity of pre-mixed epoxy to the epoxy applicator spin head.

2. The pipeline maintenance apparatus of claim 1 wherein the low-friction material is polyethylene.

3. The pipeline maintenance apparatus of claim 1 wherein the epoxy is delivered to the epoxy applicator spin head at ambient temperature.

4. The pipeline, maintenance apparatus of claim 1 wherein the motor power source fitting is a pneumatic fitting and the motor is a pneumatic motor.

5. The pipeline maintenance apparatus of claim 1 wherein the motor power source fitting is an electrical fitting and the motor is an electric motor.

6. The pipeline maintenance apparatus of claim 1 wherein, the epoxy applicator spin head includes a plurality of slots to atomize the epoxy.

7. The pipeline maintenance apparatus, of claim 1 wherein the epoxy applicator spin head includes a plurality of holes to atomize the epoxy.

8. The pipeline maintenance apparatus of claim 1 further including a pipe cleaning spin head being removably attachable to the quick-release chuck.

9. The pipeline maintenance apparatus of claim 8 wherein the pipe cleaning spin head including a plurality of filaments extending therefrom.

10. The pipeline maintenance apparatus of claim 1 further including a video camera positioned at the forward end of the body.

11. The pipeline maintenance apparatus of claim 1 wherein the skid being fabricated with a dimension of the skid at the middle being larger than dimensions of the skid at the ends of the skid.

12. The pipeline maintenance apparatus of claim 1 wherein the skid being fabricated with a dimension of the skid at the rear end being larger than a dimension of the skid at the forward end.

13. The pipeline maintenance apparatus of claim 1 wherein the pipeline maintenance apparatus being pushable through a pipe using a pushrod attachable at the rear end of the body.

14. The pipeline maintenance apparatus of claim 1 wherein the pipeline maintenance apparatus being pushable through a pipe of a dimension m the range of two inches to three feet.

15. The pipeline maintenance apparatus of claim 1 wherein the pipeline maintenance apparatus being pushable through a hollow passageway of a type from the group consisting of: a pipe, a pipeline, a vent, a duct, a conduit, a tubular hollow passageway, and a rectangular hollow passageway.

16. The pipeline maintenance apparatus of claim 1 wherein the pipeline maintenance apparatus being pushable through a hollow passageway fabricated of material from the group consisting of: metal, polyvinyl chloride (PVC), plastic, composite material, ceramic, fiberglass, and concrete.

17. The pipeline maintenance apparatus of claim wherein the pipeline maintenance apparatus being pushable through a hollow passageway with bends, turns, angles, curves, or reduced diameter segments.

18. The pipeline maintenance apparatus of claim 1 wherein the Pre-mixed epoxy is not a heat cured type of epoxy.
